(19) United States
(12) Patent Application Publication
(10) Pub. No.: US 2021/0021990 A1
(43) Pub. Date: Jan. 21, 2021

(54) DETECTION AND COMMUNICATION OF LOCKING CONFIGURATION INFORMATION MODIFICATION

(71) Applicant: QUALCOMM Incorporated, San Diego, CA (US)

(72) Inventors: Rajendra Prasad NELUROUTH, Hyderabad (IN); Naga Chandan Babu GUDIVADA, Hyderabad (IN); Venkata Konda Reddy REDDEM, Hyderabad (IN); Venkata Durga Vinod CHIKKALA, Hyderabad (IN)

(21) Appl. No.: 16/513,909

(22) Filed: Jul. 17, 2019

(51) Int. Cl. H04W 8/30; H04W 12/08; H04W 8/24; H04W 48/02; H04W 48/16; H04W 48/18; H04W 88/06

(52) U.S. Cl. CPC H04W 8/30; H04W 12/08; H04W 8/245; H04W 88/06; H04W 48/16; H04W 48/18; H04W 48/02

(57) ABSTRACT

Techniques for detecting and correcting information modification in a mobile device are provided. An example method for detecting and correcting information modification in a mobile device includes: making a determination that locking configuration information for locking the mobile device for use with a wireless network of a wireless network operator has been modified; configuring the mobile device with restored locking configuration information in response to the determination that the locking configuration information has been modified; and performing operations using the restored locking configuration information in response to the mobile device being configured to use the restored locking configuration information.

### BACKGROUND

An operator of a mobile wireless network may subsidize the cost of a mobile device, but configure or “personalize” the mobile device to limit the device for use only with the wireless network operator's wireless network. A user of the mobile device may attempt to unlock or “jailbreak” the mobile device to allow the mobile device to be used with another mobile wireless network. The wireless network operator subsidizing the cost of the mobile device may then be unable to recoup the cost of the mobile device by charging the user for mobile network access and value-added services.

### SUMMARY

An example of a mobile device includes: a memory; a transceiver for sending and receiving wireless data; a processor, communicatively coupled to the memory and the transceiver, the processor configured to: make a determination that locking configuration information for locking the mobile device for use with a wireless network of a wireless network operator has been modified; configure the mobile device to use restored locking configuration information in response to the determination that the locking configuration information has been modified; and perform operations using the restored locking configuration information in response to the mobile device being configured to use the restored locking configuration information.

Implementations of such a mobile device may include one or more of the following features. The processor is configured to: attempt to obtain the restored locking configuration information; and render the mobile device unusable in response to failing to obtain the restored locking configuration information. The processor is configured to: attempt to establish a communication connection with the wireless network operator; and render the mobile device unusable in response to failing to establish the communication connection with the wireless network operator. The processor is configured to render the mobile device unusable in response to failing to receive the restored locking configuration information via a communication connection with the wireless network operator within a threshold number of requests sent to the wireless network operator. The processor is configured to obtain the restored locking configuration information from the wireless network operator in response to being powered up a first time subsequent to the processor rendering the mobile device unusable. The processor is configured to obtain the restored locking configuration information from the wireless network operator via a communication connection, that is at least partially wireless, between the mobile device and the wireless network operator. The processor is further configured to obtain the restored locking configuration information from a protected copy of the locking configuration information stored in the memory. The processor is further configured to determine, by analyzing the locking configuration information, that the mobile device should be locked to operate only with the wireless network of the wireless network operator. To determine that the mobile device should be locked to operate only with the wireless network of the wireless network operator, the processor is configured to determine whether a fuse indicative of the mobile device being locked has been blown in a one-time programmable memory of the mobile device. The processor is further configured to send a notification via the transceiver to the wireless network operator that the locking configuration information has been modified, wherein the notification comprises information identifying the mobile device.

An example method for detecting and correcting information modification in a mobile device includes: making a determination that locking configuration information for locking the mobile device for use with a wireless network of a wireless network operator has been modified; configuring the mobile device with restored locking configuration information in response to the determination that the locking configuration information has been modified; and performing operations using the restored locking configuration information in response to the mobile device being configured to use the restored locking configuration information.

Implementations of such a method may include one or more of the following features. The method includes: attempting to obtain the restored locking configuration information; and rendering the mobile device unusable in response to failing to obtain the restored locking configuration information. The method includes: attempting to establish a communication connection with the wireless network operator; and rendering the mobile device unusable in response to failing to establish the communication connection with the wireless network operator. The method includes rendering the mobile device unusable in response to failing to receive the restored locking configuration information via a communication connection with the wireless network operator within a threshold number of requests sent to the wireless network operator.

Also or alternatively, implementations of such a method may include one or more of the following features. The method includes attempting to obtain the restored locking configuration information from the wireless network operator in response to being powered up a first time subsequent to rendering the mobile device unusable. Configuring the mobile device with the restored locking configuration information comprises receiving the restored locking configuration information for the mobile device from the wireless network operator via a communication connection, that is at least partially wireless, between the mobile device and the wireless network operator. The method includes obtaining the restored locking configuration information from a protected copy of the locking configuration information stored in a memory of the mobile device. The method includes determining that the mobile device should be locked to operate only with the wireless network of the wireless network operator prior to detecting that the locking configuration information has been modified. Determining that the mobile device should be locked to operate only with the wireless network of the wireless network operator comprises determining that a fuse indicative of the mobile device being locked has been blown in a one-time programmable memory of the mobile device. The method includes sending a notification to the wireless network operator that the locking configuration information has been modified, where the notification includes information identifying the mobile device.

An example mobile device includes: means for making a determination that locking configuration information for locking the mobile device for use with a wireless network of a wireless network operator has been modified; means for configuring the mobile device to use restored locking configuration information in response to the determination that the locking configuration information has been modified; and means for performing operations using the restored locking configuration information in response to the mobile device being configured to use the restored locking configuration information.

Implementations of such a mobile device may include one or more of the following features. The mobile device includes: means for attempting to obtain the restored locking configuration information; and means for rendering the mobile device unusable in response to failing to obtain the restored locking configuration information. The mobile device includes: means for establishing a communication connection with the wireless network operator; and means for rendering the mobile device unusable in response to failing to establish the communication connection with the wireless network operator. The means for rendering the mobile device unusable in response to failing to establish the communication connection with the wireless network operator are for rendering the mobile device unusable in response to failing to receive the restored locking configuration information via the communication connection with the wireless network operator within a threshold number of requests sent to the wireless network operator. The mobile device includes means for obtaining the restored locking configuration information from the wireless network operator in response to being powered up a first time subsequent to rendering the mobile device unusable.

An example of a non-transitory, computer-readable medium, having stored thereon computer-readable instructions for detecting and correcting information modification in a mobile device includes instructions configured to cause a processor of the mobile device to: make a determination that locking configuration information for locking the mobile device use with a wireless network of a wireless network operator has been modified; configure the mobile device to use restored locking configuration information in response to the determination that the locking configuration information has been modified; and perform operations using the restored locking configuration information in response to the mobile device being configured to use the restored locking configuration information.

Implementations of such a computer-readable medium may include one or more of the following features. The non-transitory, computer-readable medium includes instructions configured to cause the processor to: attempt to obtain the restored locking configuration information; and render the mobile device unusable in response to failing to obtain the restored locking configuration information. The non-transitory, computer-readable medium includes instructions configured to cause the processor to: establish a communication connection with the wireless network operator; and render the mobile device unusable in response to failing to establish the communication connection with the wireless network operator. The non-transitory, computer-readable medium includes instructions configured to cause the processor to render the mobile device unusable in response to failing to receive the restored locking configuration information via a communication connection with the wireless network operator within a threshold number of requests sent to the wireless network operator. The non-transitory, computer-readable medium includes instructions configured to cause the processor to obtain the restored locking configuration information from the wireless network operator in response to being powered up a first time subsequent to the processor rendering the mobile device unusable.

### BRIEF DESCRIPTION OF THE DRAWINGS

FIG. 1 is a block diagram of an example network architecture that includes one or more mobile devices.

FIG. 2 is a block diagram of a modem that may be used in the mobile device illustrated in FIG. 1.

FIG. 3 is a block diagram of an example computing device that may be used to implement the mobile device illustrated in FIG. 1.

FIG. 4 is a flow diagram of an example process for detecting and correcting information modification in a modem of a mobile device.

### DETAILED DESCRIPTION

Techniques are disclosed herein for detecting and correcting information modification in, e.g., tampering with, of a mobile device. Techniques disclosed herein may determine whether the mobile device has been locked for use with a particular wireless network operator, and determine whether locking configuration information used to configure the mobile device to operate only with (lock the mobile device for use with) the wireless network of the wireless network operator as been modified, e.g., tampered with or removed from the mobile device. While in examples discussed herein, a modem is described as being locked (for use with a particular wireless network operator) or unusable, etc., the description applies to other implementations of a mobile device being locked, unusable, etc., for example, where the locking or disabling is not implemented as part of a modem of the mobile device (e.g., where front-end circuitry is physically separate from a modem). The locking configuration information may include lock code(s), hash(es) of unlock key(s), status(es) of the lock(s), and/or other information that may be used to determine whether the modem of the mobile device is locked for usage with the network of the wireless network operator. The modem may be configured to attempt to recover the missing or corrupted locking configuration information without alerting a user of the device of the attempt to recover the locking configuration information. The detection of modification may be performed various times such as at the time that the modem and/or the mobile device is powered up or rebooted. Other events may trigger the modem and/or the mobile device to determine whether modification has occurred, such as detecting a profile swap from one network provider to another network provider. The modem may be permitted to continue initialization and to connect to a wireless network associated with another wireless network operator for at least a limited period of time to allow the modem and/or the mobile device to connect to the wireless network operator and notify the wireless network operator of the modification. The wireless network operator may facilitate recovery of the locking configuration information and/or may instruct the modem and/or the mobile device to perform one or actions in response to the modification. The functionality of the modem and/or the mobile device may be limited, and/or the modem and/or the mobile device may be rendered temporarily or permanently inoperable if the locking configuration information cannot be recovered. If the missing and/or corrupted locking configuration information may be restored, the modem and/or the mobile device may once again be operated with the wireless network of the wireless network operator but not with the networks of other network operators. These techniques may be applied automatically by the modem and/or the mobile device to quickly detect and recover from information modification using the locking configuration information without alerting a user of the mobile device that such a recovery is being made.

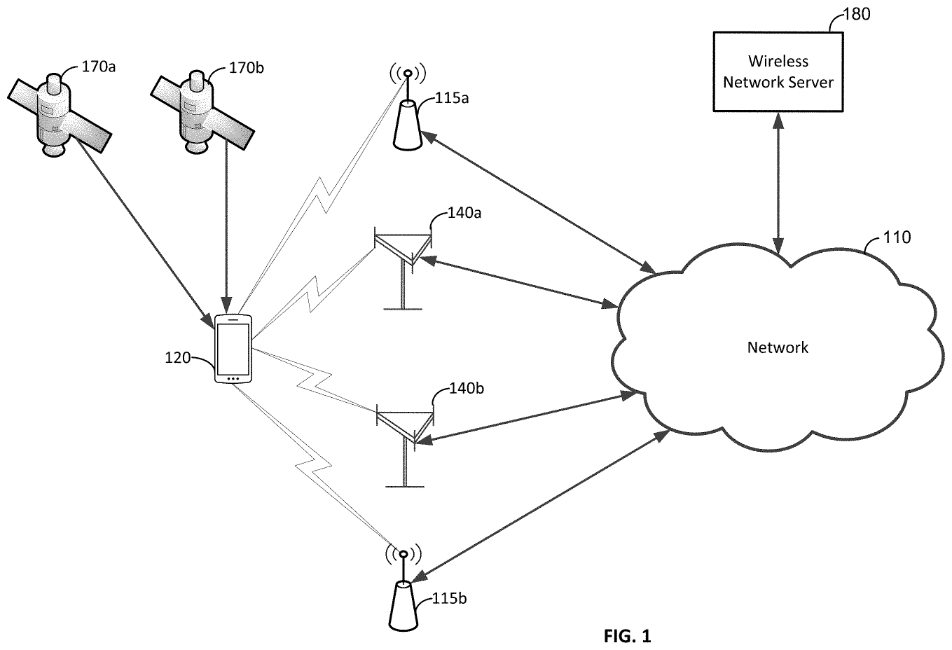

FIG. 1 is a block diagram of an example network architecture, which may be suitable for implementing techniques discussed herein. The particular configuration illustrated herein is an example of one network configuration in which techniques disclosed herein may be used. Furthermore, an implementation of such a network architecture may not include all of the elements shown and/or may include one or more additional elements that are not illustrated herein and have been omitted for the sake of clarity. The example network architecture of FIG. 1 includes a mobile device 120, a network 110, a wireless network server 180, wireless transmitters 115a, 115b, wireless base stations 140a, 140b, and satellites 170a, 170b.

The mobile device 120 may also be referred to as a User Equipment (UE), a mobile station, a terminal, an access terminal, a subscriber unit, a station, etc. The mobile device 120 may be a smartphone, a tablet computer, a laptop computer, smart watch or other type of wearable computing device, or other computing device that includes a modem that is configured to facilitate communications using one or more wireless communications protocols, including, but not limited to, the Long Term Evolution (LTE), 5G New Radio (NR), WiFi, and BLUETOOTH® wireless communications protocols. The mobile device 120 may be configured to support one or more other types of wireless communications protocols and may be configured to support multiple different wireless communications protocols. A wireless transmitter of the mobile device 120 may be configured to send data to and/or receive data from other mobile devices (not shown), the wireless transmitters 115a, 115b, and/or the wireless base stations 140a, 140b. The mobile device 120 may be subsidized (e.g., at least partially paid for) by a wireless network operator (a subsidy network operator), and the wireless network operator may lock the mobile device to operate only with the network operator's wireless network. The wireless network operator is an entity that provides wireless network access and other services to wireless devices, such as the mobile device 120. The wireless network operator may limit access to the wireless network and other services to subscribers of the wireless network.

The mobile device 120 may be configured to include a Satellite Positioning System (SPS) receiver configured to receive and measure signals from one or more satellites, such as satellite 170a and satellite 170b in this example, and to obtain pseudo-range measurements for the satellites 170a, 170b. The satellites 170a, 170b may be part of a Global Navigation Satellite System (GNSS), which may be the United States Global Positioning System (GPS), the European Galileo system, the Russian GLONASS system, or some other GNSS. The GNSS receiver may be configured to detect and receive signals from satellites belonging to more than one GNSS system. For example, satellite 170a could belong to the GPS system while the satellite 170b could belong to the Galileo system. While the example network architecture illustrated herein illustrates only two satellites, other implementations may have more or less satellites available, and the number of satellites visible to the mobile device 120 may depend upon the current geographical location of the mobile devices and the orbits of the satellites.

The wireless transmitters 115a, 115b may each comprise a wireless local access network (WLAN) wireless access point. The wireless transmitters 115a, 115b may each comprise a femtocell, a picocell, a remote radio head, a microcell, or other type of wide area network (WWAN) base station. The wireless transmitters 115a, 115b may also comprise other types of terrestrial transceivers. Some network environments may include more than one type of wireless transmitter. The wireless transmitters 115a, 115b may be connected to the network 110 via a backhaul connection that provides a broadband connection to the network 110. The network 110 may be the Internet and/or a combination of one or more networks. For example, the wireless transmitters 115a, 115b may be connected to a DSL modem or a cable modem, depending upon the type of broadband service being used in that particular implementation. Other types of backhaul connections may also be utilized. The wireless transmitters 115a, 115b may be associated with the network operator, and may be configured to communicate with the network operator's network (not shown) via the network 110. The coverage area of a wireless transmitter 115a, 115b may overlap with that of one or more wireless base stations, such as the wireless base stations 140a, 140b, or that of one or more other terrestrial transceivers.

The wireless base stations 140a, 140b may be configured to provide wireless network connectivity to a plurality of mobile devices. The wireless base stations 140a, 140b may each comprise a macrocell base station which is associated with a WWAN. The wireless base stations 140a, 140b may be associated with the same network operator or different network operators. One or both of the wireless base stations 140a, 140b may have a much larger coverage area than the wireless transmitters 115a, 115b and/or may be a terrestrial transceiver that provides a coverage area that is of a similar size or of a smaller size than the coverage area provided by the wireless transmitters 115a, 115b. The wireless base stations 140a, 140b may be configured to communicate using one or more wireless communications protocols. While the example illustrated in FIG. 1 includes only two wireless base stations, i.e., the wireless base stations 140a, 140b, other implementations of the network environment may include fewer or more wireless base stations. The wireless base stations 140a, 140b and the wireless transmitter 115a, 115b may be associated with the same wireless network operator, each of the wireless base stations 140a, 140b and the wireless transmitter 115a, 115b may be associated with different network operators, or subsets of the wireless base stations 140a, 140b and the wireless transmitter 115a, 115b may share a common network operator.

The mobile device 120 may be configured to communicate with the wireless network server 180. The wireless network server 180 may be associated with a network operator that has subsidized the cost of the mobile device 120. The wireless network server 180 may provide various services to the mobile device 120, including but not limited to, verification of whether the mobile device 120 is locked for use with the wireless network operator. The wireless network server 180 may provide an interface to facilitate unlocking the mobile device 120. The wireless network server 180 may provide locking configuration information to the mobile device 120 for configuring the mobile device 120 to operate with the wireless network of the wireless network operator.

The network configuration illustrated in FIG. 1 is an example of a possible configuration of a network in which techniques disclosed herein may be implemented. Other network configurations may be used, including configurations that include additional elements not illustrated in FIG. 1 or configurations where the various components are interconnected in a different configuration than what is shown in FIG. 1.

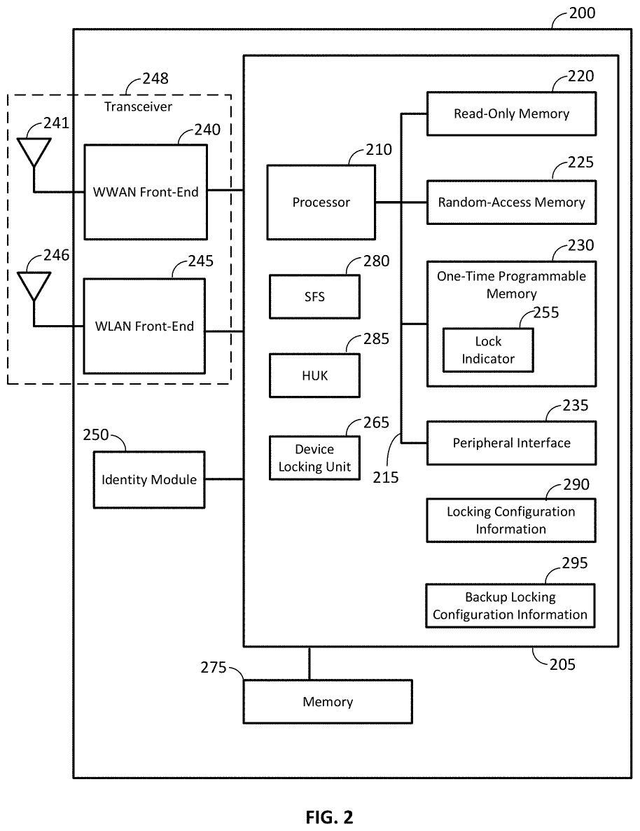

FIG. 2 is a block diagram of an example modem 200 that may be used in the mobile device 120 illustrated in FIG. 1. The modem 200 is an example configuration of a modem that may be used to implement techniques disclosed herein, but does not limit these techniques to a modem of this specific configuration. As shown, the modem 200 in this example is connected to a WWAN antenna 241 and a WLAN antenna 246. Other configurations are possible, e.g., with more or fewer antennas, and/or one or more antennas configured for transmission/reception of signals other than WWAN or WLAN signals.

The modem 200 may include an integrated circuit 205 that includes a processor 210, a read-only memory (ROM) 220, a random-access memory (RAM) 225, one-time programmable memory (OTPM) 230, a peripheral interface 235, and an interconnect 215. The modem 200 may also include a memory 275 that is external to the integrated circuit 205. In some implementations, the modem 200 may have memory (not shown) that is implemented on the integrated circuit 205 instead of or in addition to the memory 275. The modem 200 may also include an identity module 250.

The identity module 250 may store information for identifying and authenticating a subscriber to a mobile network. The identity module 250 may be internal to the modem 200 as illustrated in FIG. 2, or may be external to the modem 200 and communicably coupled with the modem 200 so that the modem 200 may read data from and/or write data to the identity module 250. The identity module 250 may comprise one or more subscriber identity module (SIM) cards, an embedded universal integrated circuit card (eUICC), and/or other type of device for securely identifying and authenticating a subscriber to a wireless network operator. A SIM card is an integrated circuit that stores a subscriber profile (also referred to herein as a “SIM profile”) that may be used to identify and authenticate a subscriber to a particular network operator. The SIM profile includes information that may be used to identify and authenticate a subscriber with a particular wireless network operator. The SIM profile may include an international mobile subscriber identify (IMSI), which comprise an identifier of a particular network operator with which the subscriber is associated, and a unique identifier associated with the subscriber on the specified network. A SIM card is typically removable, and may be removed and replaced with another SIM card to enable the modem 200 to be with a different network operator. The modem 200 may also be a multi-SIM device that may accept multiple SIM cards, and a user may select a SIM card to be used to attempt to establish a connection with a wireless network.

The identity module 250 may comprise an eUICC instead of a SIM card. The eUICC may be embedded in the modem 200 or the mobile device 120 comprising the modem 200. The eUICC may support multiple SIM profiles, unlike a SIM card which typically supports only a single SIM profile. Each SIM profile may be used to connect with the wireless network of a specific network operator. The eUICC facilitates switching between SIM profiles, which helps the modem 200 to switch between networks associated with different network operators without having to physically replace a SIM card. A user may select a particular SIM profile to be used to attempt to establish a connection with a wireless network. Furthermore, the eUICC may be programmed over the air to use a specific profile, and SIM profiles may be added, removed, or modified over the air. The phrase “over the air” as used herein refers to the eUICC being provisioned or configured by receiving commands and/or data over a wireless network connection.

The modem may also include one or more front-end units for transmitting and receiving RF signals, such as a WWAN front-end 240 and/or a WLAN front-end 245. The front-end units 240, 245 combined with the antennas 241, 246 comprise a transceiver 248 configured to transmit and receive radio-frequency (RF) signals. The front-end units may comprise circuitry configured to process RF signals received by one or more of the antennas 241, 246 connected to the modem 200. The RF front-end units may include one or more filters, one or more RF amplifiers, a local oscillator (LO), and a mixer for mixing RF signals with a signal from the LO to convert the RF signals to a frequency suitable for processing by the processor 210 of the modem 200. The example implementation of the modem 200 illustrated in FIG. 2 includes two front-end units, the WWAN front-end 240 for RF signals associated with a wireless wide area network (WWAN) and the WLAN front-end 245 for RF signals associated with wireless local area network (WLAN). The WLAN front-end 245 may be configured to support WiFi and/or other wireless local area network communication protocols, and the WWAN front-end 240 may be configured to support Long Term Evolution (LTE), 5G NR, and/or other wireless wide area network communication protocols. Some implementations may include a single RF front-end that may be configured to handle signals from multiple frequency bands. Other implementations may also have more than the two RF front-ends illustrated in this example, or may have one or more other RF front-ends configured to handle other types of RF signals instead of or in addition to one or more of the RF front-ends illustrated in FIG. 2. The RF front-end(s) may be communicably coupled to the integrated circuit 205, meaning that the components of the integrated circuit 205 may receive data output by the RF front-end(s) based on RF signals received by the RF front-end(s) and/or send data to the RF front-end(s) to be transmitted as RF signals.

The integrated circuit 205 may comprise a system on a chip (“SoC”) that integrates the processor 210, the ROM 220, the RAM 225, the OTPM 230, the peripheral interface 235, and the interconnect 215 on the same integrated circuit or chip. In other implementations, one or more of these components may be implemented as separate components that are not components of the same integrated circuit. The integrated circuit includes an interconnect 215 or communication fabric that serves to interconnect the components of the integrated circuit 205.

The processor 210 may comprise a general-purpose processor, which may be connected to the other components of the integrated circuit 205 via the interconnect 215. The processor 210 may include one or more microprocessors, microcontrollers, and/or digital signal processors that provide processing functions, as well as other calculation and control functionality. The processor 210 may be coupled to storage media (e.g., memory) for storing data and software instructions for executing programmed functionality within the modem 200. The memory may be on-board the processor 210 (e.g., within the same IC package), and/or the memory may be external memory to the processor 210 and functionally coupled to the processor 210 by a data bus or interconnect.

The ROM 220 comprises read-only non-volatile memory that is configured to retain the contents of the memory even if power to the memory is lost. The ROM 220 may include program code that is executed in response to the modem 200 being powered up or rebooted. The ROM 220 may also include program code that is executed in response to an event that causes the identity module 250 to switch from a first profile associated with a first wireless network operator to a second profile associated with a second wireless network operator. For example, the ROM 220 may include SIM lock program code that may be executed by the processor 210 to determine whether the modem has been locked to operate with a wireless network of a specific network operator.

The RAM 225 may comprise volatile memory that is configured to maintain the data stored therein while power is provided to the memory. However, the contents of the RAM 225 may be lost if power to the memory is lost or the power supply drops below a level required to operate the RAM 225. The processor 210 may store data used by the processor 210 and/or executable program instructions to be executed by the processor 210 in the RAM 225.

The peripheral interface 235 may comprise general purpose input/output pins that may be used to receive or output data from the modem 200 and/or to connect with peripheral devices. The peripheral interface 235 may be configured to support various communication protocols, including but not limited one or more of the following: General Purpose Input Output (GPIO), Joint Test Action Group (JTAG), Integrated Inter-IC Sound Bus (I²S), Universal Serial Bus (USB), Secure Digital Input Output (SDIO), Quad Serial Peripheral Interface (QSPI), Universal Asynchronous Receiver-Transmitter (UART), High-Speed UART (HS UART), and/or other communication protocols. The peripheral interface 235 may be configured to send data to and receive data from various peripherals, such as sensors, and provide an interface that may be used to communicate with other components of a computing device in which the modem 200 is installed, such as the mobile device 120.

The modem 200 may include a secure file system (SFS) 280 that is configured to encrypt files and directories managed by the SFS 280 to help prevent modification (e.g., changing or removal) of the data maintained by the SFS 280. The SFS 280 may be configured to monitor the data maintained by the SFS 280 to detect data modifications. The SFS 280 may be configured to detect a change to even a single bit of the data stored therein. The SFS 280 may utilize checksums or other means for verifying data integrity.

The SFS 280 may use a device hardware key that is unique to each device when encrypting the contents of the filesystem maintained by the SFS 280. The example modem 200 includes a Hardware Unique Key (HUK) 285. The HUK 285 may comprise a bit string that is stored in the OTPM 230 and/or in another secure memory location of the modem 200 that is accessible by the processor 210 but is inaccessible to untrusted program code and inaccessible from outside of the modem 200. The HUK 285 may be generated and programmed into the OTPM 230 by an original equipment manufacturer (OEM) of the modem 200. The SFS 280 may use the HUK 285 as a cryptographic key for encrypting and decrypting the contents of the file system or may be configured to derive cryptographic keys from the HUK 285. The SFS 280 may provide an interface, for accessing, updating, adding to or deleting from the contents of the file system, to the processor 210 and/or to one or more other trusted components of the modem 200.

The locking configuration information 290 (also referred to as “personalization information”) may include information for locking the modem for use with a wireless network of a wireless network operator. The wireless network operator may have subsidized the mobile device in which the modem 200 has been installed. The locking configuration information 290 may be used to determine whether the mobile device is locked for usage with the network of a wireless network operator and may include one or more lock codes, one or more hashes of unlock keys, one or more statuses of the lock(s), and/or other information.

The lock code(s) may be read by the device locking unit 265 (described in detail below), e.g., in response to (e.g., when) the modem 200 is powered up or reset. The lock code(s) included in the locking configuration information 290 may indicate that the modem 200 is locked for use with a wireless network associated with a particular wireless network provider. The device locking unit 265 may be configured to prevent a SIM card or SIM profile associated with another wireless network provider from being used to establish a wireless connection with the other wireless network provider. The lock code(s) may include region lock code(s) that impose one or more geographical limitations on the wireless networks to which the modem 200 may connect. For example, the region lock code(s) may indicate one or more geographical regions in which the modem 200 is permitted to connect with a wireless network. As another example, the region lock code(s) may also or alternatively indicate one or more geographical regions in which the modem 200 is not permitted to connect with a wireless network.

The locking configuration information 290 may include one or more unlock codes that can be used to release one or more locks imposed by the lock code(s). Each lock code may be associated with one or more unlock codes, and a particular unlock code may be used to remove a lock associated with one or more lock codes. The modem 200 may provide an interface that allows a user of the mobile device 120 to enter one or more unlock codes to release the lock(s) imposed by the lock code(s). The one or more unlock codes may be obtained from the wireless network operator that imposed the lock(s). The wireless network operator may have subsidized the mobile device 120 and may require a payment before providing the unlock code(s). The device locking unit 265 may compare an unlock code input by a user of the mobile device 120 with the one or more unlock codes stored in a memory of the modem 200 to determine whether the unlock code provided is valid. If the unlock code is valid, then the device locking unit 265 may release the lock imposed by the lock code(s) with which the unlock code is associated.

The locking configuration information 290 may include information indicative of the status of the lock(s) imposed by the lock code(s). The device locking unit 265 may set an indicator in the locking configuration information 290 indicating that a particular lock code has been unlocked. The device locking unit 265 may update the backup locking configuration information 295 to indicate that the lock code has been unlocked where the modem 200 is configured to maintain such backup locking information on the device. Unlocking of the lock code may be a permanent and irreversible process, or the unlocking may be a temporary process (e.g., for a predetermined period of time). For example, the wireless network operator may permit the mobile device 120 to be used with one or more wireless networks outside of a predetermined geographical area for a predetermined period of time in response to a subscriber requesting that the mobile device 120 be able to be used while the subscriber is traveling outside of the predetermined geographical area where the device is typically permitted to be used. The device locking unit 265 may be configured to read the indicator associated with each lock code in response to initializing the modem 200, e.g., upon powering up or resetting the modem 200, and the device locking unit 265 may be configured to disregard any lock code for which there is an indication that the lock code has been unlocked. The device locking unit 265 may or may not impose one or more restrictions on usage associated with the unlocked lock code(s).

The locking configuration information 290 may be stored in a persistent memory of the modem 200, including but not limited to the memory 275. The SFS 280 may provide means for detecting modification of the locking configuration information. The locking configuration information 290 may be maintained by the SFS 280, and the SFS 280 may detect attempts to modify (e.g., alter or delete or replace) the locking configuration information 290. The SFS 280 may be configured to respond to a read request for the locking configuration information 290, e.g. from the device locking unit 265, with an indication that the locking configuration information 290 has been modified if such is the case. The SFS 280 may be configured to generate a read error responsive to detecting that the locking configuration information 290 has been modified. The read error may indicate to the device locking unit 265 that the locking configuration information 290 has been modified.

The OTPM 230 is a non-volatile memory that retains the contents of the memory even if power to the memory is lost or falls below a level required to operate the memory. The OTPM 230 may comprise a plurality of fuses that each represent a bit of data, and the value of a particular bit may be set by blowing or not blowing the corresponding fuse. The value of a fuse, once blown, cannot be changed. The value of the fuse in its original state may be used to represent a bit value of zero (‘0’), and the value of the fuse once blown may be used to represent a bit value of one (‘1’). In other embodiments, the value of the fuse in its original state may be used to represent a bit value of one (‘1’), and the value of the fuse once blown may be used to represent a bit value of one (‘0’). Furthermore, other types of OTPM 230 may be used. The OTPM 230 may comprise antifuses or other components that may be set once and that may be used to represent a bit of data instead of fuses. One or more bits of the OTPM 230 may be set to indicate that the modem 200 is locked to operate with the wireless network of a wireless network operator. In some implementations, the locking configuration information 290 associated with the wireless network operator may be stored in the OTPM 230. In other implementations, the locking configuration information may be stored in another non-volatile memory of the modem 200, such as the memory 275.

The device locking unit 265 may be implemented as hardware, processor-executable program code executable by the processor 210, or a combination thereof. The processor-executable program code may comprise firmware, which may be stored in the ROM 220, or software stored in a persistent memory of the modem 200, or a combination of firmware and software.

The device locking unit 265 may provide means for determining whether the modem 200 is locked for usage with a network associated with a network operator and may be triggered to do so at the time that the modem 200 is powered up or rebooted. Locking of a device for usage with the network of a particular network operator may, for example, be referred to as SIM locking, subsidy locking, network locking, or carrier locking. A user may attempt to “jailbreak” the mobile device 120 by removing or corrupting the locking configuration information 290 that configures the modem 200 to only operate with wireless network(s) associated with the wireless network operator. The user may insert a SIM card or select a SIM profile that is not associated with the wireless network operator. Accordingly, the device locking unit 265 may also be triggered (to determine whether the modem 200 is locked to a network) in response to the SIM card being swapped or a profile swap event.

The device locking unit 265 may permit the modem 200 to be used with a SIM card or SIM profile associated with any network operator if the modem is not locked. The device locking unit 265 may not determine whether the mobile device is subscribed to or otherwise permitted to use the wireless network of the network operator for which the SIM card has been inserted or the SIM profile has been selected. The network operator may determine the status of the subscriber associated with the SIM card or SIM profile. A user may attempt to connect to or otherwise attempt to obtain network services from a network operator to which the user is not currently subscribed, and the network operator may refuse the network connection with the mobile device 120.

The device locking unit 265 may comprise means for determining whether the modem 200/the mobile device 120 is locked by checking for a lock indicator 255 in memory of the modem 200. The lock indicator 255 may comprise one or more bits of the OTPM 230. The one or more bits of the OTPM 230 may be set by the wireless network operator to indicate that the modem 200 is locked for use with that particular network operator. A wireless network operator identifier may also be stored in the OTPM 230. The lock indicator 255 and/or the wireless network operator identifier may indicate to the device locking unit 265 that the modem 200 is locked and that locking configuration information 290 for configuring the modem to operate with the wireless network of the wireless network operator should be stored on the modem 200. The device locking unit 265 may be configured, for example, to look for the locking configuration information 290 in a specific memory location, or look for a specific file, or look for a specific directory maintained by the SFS 280 for the locking configuration information. The device locking unit 265 may attempt to recover the locking configuration information 290 in response to determining that the locking configuration information 290 is missing or corrupted. The locking configuration information 290 may be recovered from a backup copy of the locking configuration information 290 stored on the modem 200, if available, or from the wireless network operator by sending a notification to the wireless network operator that the locking configuration information 290 is missing or corrupted. The device locking unit 265 may permit the modem 200 to connect to a wireless network not associated with the wireless network operator to allow the device locking unit 265 to send a notification that the locking configuration information 290 has been modified (e.g., that the locking configuration information 290 is missing or corrupted) to the wireless network server 180 via the network connection.

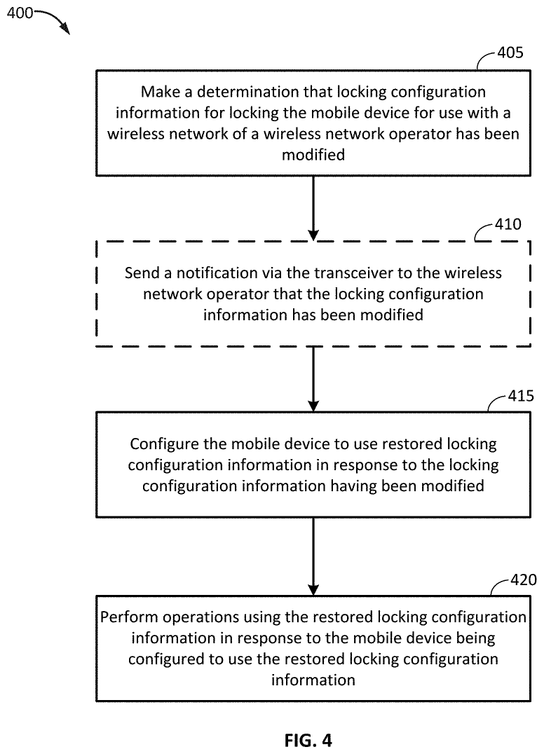

The device locking unit 265 may attempt to recover the locking configuration information 290 associated with the wireless network operator if the locking configuration information is missing or has been corrupted. The process illustrated in FIG. 4, discussed below, is an example process which may be implemented by the device locking unit 265 for recovering the locking configuration information 290.

The device locking unit 265 may limit the functionality of the modem 200 and/or the mobile device comprising the modem 200 to prevent the mobile device from utilizing full network connectivity. The device locking unit 265 may render the modem 200 temporarily unusable in response to determining that the locking configuration information 290 has been modified (e.g., deleted or corrupted). The device locking unit 265 may also render the modem 200 temporarily usable and allow the modem to connect to a wireless network associated with a network operator other than the wireless network operator to allow the device locking unit 265 to notify the wireless network operator that the mobile device comprising the modem 200 has been unlocked, e.g., for use with the other network operator. The term “unusable” as used herein may refer to the modem 200 being configured to operate in a state where the modem 200 is configured not to send and/or receive data on behalf of other components of the mobile device 120. The modem 200 may be able to send and/or receive data on behalf of components of the modem 200 while the modem 200 is in the unusable state. The device locking unit 265 may be able to send and/or receive data while the modem 200 is in the unusable state to allow the device locking unit 265 to send data to and/or receive data from the wireless network server 180 and/or other entities on behalf of the network operator to which the modem 200 is locked. The term “temporarily unusable” refers to the modem 200 operating in a state where the modem 200 is configured not to send and/or receive data on behalf of other components of the mobile device 120 for a period of time, after which the modem 200 may return to a “usable” state in which the modem 200 may send data and/or receive data on behalf of other components of the mobile device 120. In some implementations, the modem 200 may be configured not to send and/or receive any data while the modem 200 is in the unusable state and the modem 200 may be in a state in which the modem 200 is unable to establish a connection with a wireless network. The period of time during which the modem 200 may remain in the unusable state may be randomly determined by the device locking unit 265, or the device locking unit 265 may be configured to return the modem 200 to the usable state at predetermined intervals.

The device locking unit 265 may maintain backup locking configuration information 295, which may be a protected copy of the locking configuration information 290 or information that may be used to recreate the locking configuration information 290. The backup locking configuration information 295 may be protected, e.g., by being stored securely and/or encrypted, obfuscated, and/or otherwise made difficult to locate and remove. The backup locking configuration information 295 may be stored in a persistent memory of the modem 200, including but not limited to the OTPM 230 and/or the memory 275. The backup locking configuration information 295 may be stored in another persistent memory location of the modem 200. The backup locking configuration information 295 may be used by the device locking unit 265 to restore the locking configuration information 290 in response to the device locking unit 265 determining that the locking configuration information 290 has been modified (e.g., altered, deleted, or replaced). The backup locking configuration information 295 may be encrypted or obfuscated or otherwise rendered difficult to locate and remove, e.g., by the device locking unit 265, from the modem 200.

The modem 200 may provide a programming interface that may accept commands from a user via a user interface of the mobile device 120, e.g. a touchscreen, keyboard, or other user interface components. The programming interface may be implemented by processor-executable program code that is executable by the processor 210 and is stored in the ROM 220, the RAM 225, or another memory of the modem 200. The programming interface may allow a user of the mobile device 120 to configure at least some operating parameters of the modem 200 to alter, delete, or replace the locking configuration information 290 used by the modem 200. The modem 200 may include a backup copy of the locking configuration information 290, e.g. the backup locking configuration information 295, stored in a memory location in which the backup locking configuration information 295 cannot be altered, deleted, or replaced via the programming interface. The device locking unit 265 may monitor inputs received via the programming interface to identify that an input has been received to alter, delete, or replace the locking configuration information 290. The device locking unit 265 can be configured to replace the locking configuration information 290 that has been altered, deleted, or replaced with a copy of the backup locking configuration information 295 stored in the memory of the modem 200. The device locking unit 265 may copy the backup locking configuration information 295 from the memory location in which the backup locking configuration information 295 is stored to the memory location where the locking configuration information 290 was stored before being altered, deleted, or replaced. Some implementations of the modem 200 may not include the backup locking configuration information 295 stored on the device, and the device locking unit 265 may attempt to recover the locking configuration information 290 from elsewhere, e.g., from the network operator, in such configurations.

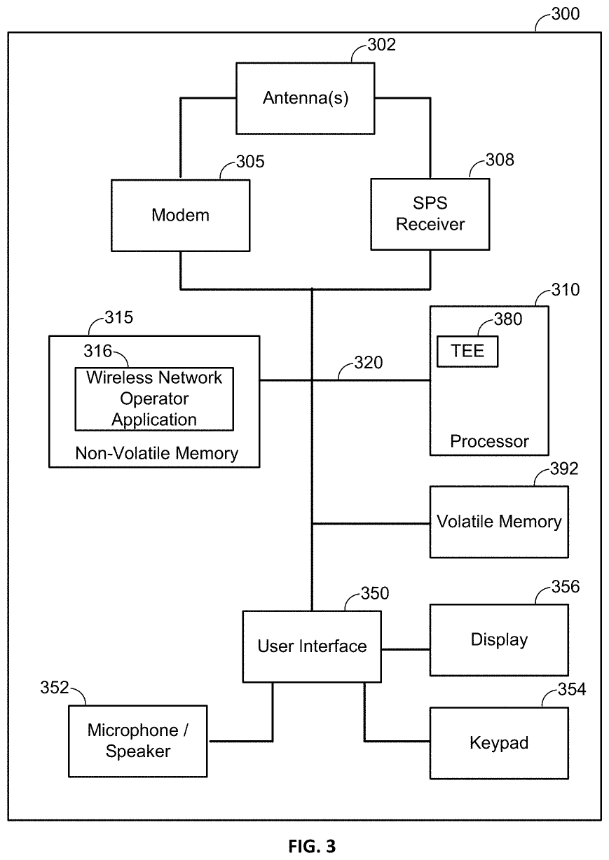

FIG. 3 is a simplified block diagram of an example computing device 300 that may be used to implement the mobile device 120 illustrated in FIG. 1. FIG. 3 is a schematic diagram illustrating various components of the example computing device 300, which may be similar to or the same as the mobile device 120 depicted in FIG. 1. The various features/components illustrated in the schematic boxes of FIG. 3 are operatively coupled together, e.g., being directly or indirectly (e.g., via one or more intermediate components) connected. The components of the computing device 300 may be communicatively connected to one another via one or more busses or interconnects, such as an interconnect 320. Other connections, mechanisms, features, functions, or the like, may be provided and adapted to operatively couple and configure a portable wireless device. Furthermore, one or more of the features illustrated in the example of FIG. 3 may be further subdivided, or two or more of the features illustrated in FIG. 3 may be combined. Additionally, one or more of the features illustrated in FIG. 3 may be excluded. The features shown may be combined, separated, and/or be structured in different ways depending upon the implementation of the computing device 300.

The computing device 300 may include one or more modems 305, which may include the modem 200 illustrated in FIG. 2. The modem 305 may be connected to one or more antennas 302 for receiving and/or transmitting RF signals. The modem 305 comprises suitable devices, circuits, hardware, and/or software for communicating with and/or sending signals to and/or detecting signals from one or more other wireless devices. The modem 305 may be configured to communicate using one or more types of wireless communication protocol, which may include but is/are not limited to WiFi (IEE 802.11x) communication protocol and/or one or more protocols for one or more other types of local area network (LAN). The modem 305 may be configured to support short-range wireless networking protocols, such as but not limited to Bluetooth®, Ultra Wide Band, ZigBee, and/or wireless USB. The modem 305 may be configured to support Wide Area Network (WAN) communication protocols, such as but not limited to Long Term Evolution (LTE), 5G NR, Code-Division Multiple Access (CMDA), Time-Division Multiple Access (TDMA), Global System for Mobile Communications (GSM), Wide-Band Code Division Multiple Access (WCDMA), and/or other WAN wireless communication protocols.

In some embodiments, a satellite positioning system (SPS) receiver (also referred to as a global navigation satellite system (GNSS) receiver) 308 may be included with the computing device 300. The SPS receiver 308 may be connected to the one or more antennas 302 for receiving satellite signals. The SPS receiver 308 may comprise any suitable hardware and/or software for receiving and processing SPS signals. The SPS receiver 308 may request information as appropriate from the other systems, and may perform the computations to determine the position of the computing device 300 using, in part, measurements obtained by any suitable SPS procedure.

The processor (also referred to as a controller) 310 may include one or more microprocessors, microcontrollers, and/or digital signal processors that provide processing functions, as well as other calculation and control functionality. The processor 310 may be coupled to non-transitory computer-readable storage media (e.g., memory 315) for storing data and software instructions, and the processor 310 may execute the software instructions to perform functions discussed herein. The memory 315 may be on board the processor 310 (e.g., within the same integrated circuit package), and/or the memory 315 may be external memory to the processor 310 and functionally coupled over a data bus or interconnect, such as the interconnect 320. The memory 315 may comprise non-volatile computer-readable media that may be used by the processor 310 to store executable program code. The processor 310 may also be coupled to volatile memory 392. The volatile memory 392 comprises computer-readable memory that will lose the contents stored therein when power is lost to the memory 392. The processor 310 may also include non-volatile memory (not shown).

A number of software units and data tables may reside in the memory 315 and may be utilized by the processor 310 in order to manage communications with remote devices/nodes, perform positioning determination functionality, and/or perform device control functionality. As illustrated in FIG. 3, in some embodiments, the memory 315 may include a wireless network operator application 316. The wireless network operator application 316 may be realized, at least partially, as a hardware-based implementation. The memory 315 may also include other executable program code that may be executed by the processor 310.

The processor 310 may include a trusted execution environment (TEE) 380. The trusted execution environment 380 may be implemented as a secure area of the processor 310 that may be used to process and store sensitive data in an environment that is segregated from the rich execution environment in which the operating system and/or applications (such as the wireless network operator application 316) may be executed. The trusted execution environment 380 may be configured to execute trusted applications that provide end-to-end security for sensitive data by enforcing confidentiality, integrity, and protection of the sensitive data stored therein. The trusted execution environment 380 may be used to store encryption keys and/or other sensitive data.

The computing device 300 may include a user interface 350 providing suitable interface systems, such as a microphone/speaker 352, a keypad 354, and a display 356 that allows user interaction with the computing device 300. The microphone/speaker 352 provides for voice communication services (e.g., for voice input and audible output). The keypad 354 may comprise suitable buttons for user input. The display 356 may include a suitable display, such as, for example, a backlit liquid crystal display (LCD), and may comprise a touch screen display for additional user input modes.

The wireless network operator application 316 may be installed on the computing device 300 by, or on behalf of, the wireless network operator. The wireless network operator application 316 may be configured to operate in conjunction with the modem 305 to detect modification of the locking configuration information 290 and to recover the locking configuration information 290. The wireless network operator application 316 may send data to and/or receive information from the device locking unit 265 of the modem 305. The wireless network operator application 316 may include position information for the computing device 300 in a notification provided to the wireless network operator. The wireless network operator application 316 may be configured to obtain the position information for the computing device 300 in response to a request from the device locking unit 265. The wireless network operator application 316 may obtain a position solution from the SPS receiver 308, estimate a location of the mobile device based on signals received from one or more wireless transmitters, such as but not limited to the wireless base stations 140a, 140b and the wireless transmitter 115a, 115b, and/or access a previously determined precise location or estimated location of the computing device 300 determined within a predetermined threshold time of the request for the location. The wireless network operator application 316 may prompt a user of the computing device 300 to enter an unlock code or purchase an unlock code for unlocking the modem 305. The wireless network operator application 316 may handle a payment transaction for purchasing the unlock code, for sending a notification of the payment transaction to the wireless network server 180, and for receiving the unlock code from the wireless network server 180 in response to the notification of the payment. The wireless network operator application 316 may be configured to wait for a period in which the modem 305 is configured to enable network communications to attempt to obtain an unlock code. The wireless network operator application 316 may be configured to send a request to the modem 305 to allow, e.g., temporarily, network communications even though the SIM card inserted by the user or a SIM profile selected by the user is not that of the wireless network provider. The wireless network operator application 316 may provide an interface through which the user may enter a lock code, e.g., that has been obtained through other means, such as the user calling or visiting the wireless network provider to obtain the unlock code. The wireless network operator application 316 may be configured to perform at least a portion of the functionality of the device locking unit 265 discussed above.

FIG. 4 is a flow diagram of a process 400 for operating a modem of a mobile device. The process illustrated in FIG. 4 may detect and correct information modification in the modem of the mobile device. The process illustrated in FIG. 4 may be implemented by the processor 210 and/or the device locking unit 265 of the modem 200 illustrated in FIG. 2. This process may be used to detect the modification of the locking configuration information 290 and restore the locking configuration information 290. Restoring the locking configuration information 290 may be executed quickly and without notifying a user of the device to help prevent the user of the device from being able to take action to prevent the restoration of the locking configuration information 290.

Modification of locking configuration information 290 for locking the modem 200 for use with a wireless network of a wireless network operator may be detected (stage 405). The device locking unit 265 may determine whether the modem 200 is locked prior to attempting to access the locking configuration information 290. The device locking unit 265 may access the OTPM 230 to determine whether the lock indicator 255 has been set to indicate that the modem 200 has been locked for use with a particular wireless network operator. The lock indicator 255 may comprise one or more bits of the OTPM 230, and the one or more bits may be set to a predetermined value indicative of the modem 200 being locked to operate with a particular network operator. The device locking unit 265 may access the lock indicator 255, e.g., when the modem 200 is powered up, rebooted, or reset. The modem 200 may be powered up, rebooted, or reset in response the mobile device 120, in which the modem 200 is integrated, being powered up, rebooted, or reset. The device locking unit 265 may access the locking configuration information 290 in response to the lock indicator 255 being set, and determine whether the locking configuration information 290 has been modified in response to accessing the locking configuration information 290.

The device locking unit 265 may attempt to access the locking configuration information 290 in response to determining that the modem 200 is locked. The locking configuration information 290 may be stored in the OTPM 230 and/or in the memory 275 of the modem. The modem 200 may include SFS 280, and the device locking unit 265 may provide a read request to the SFS 280. As discussed above, the SFS 280 may detect whether the locking configuration information 290 has been modified, and may generate a read error responsive to detecting that the locking configuration information 290 has been modified. The read error indicates to the device locking unit 265 that the locking configuration information 290 has been modified.

Some implementations of the modem 200 may not include the SFS 280, and the device locking unit 265 may detect changes to the locking configuration information 290. One approach that the device locking unit 265 may use to detect changes to the locking configuration information 290 is to determine a hash value, a message authentication code (MAC), a checksum, or other indicator that may be used to determine that the locking configuration information 290 has been modified after the indicator is determined. The device locking unit 265 may store this indicator in the OTPM 230 or other persistent memory of the modem 200. The device locking unit 265 may then redetermine this indication when accessing the locking configuration information 290 at a later time, and compare this indication with the previously determined indication. If the two values of the indication do not match, then the locking configuration information 290 has been modified. Alternatively, the device locking unit 265 may determine that the locking configuration information 290 has been modified by comparing the locking configuration information to the backup locking configuration information 295. As discussed above, the backup locking configuration information 295 may be stored in a memory or portion of memory of the modem that is substantially inaccessible to other components of the modem 200 to prevent an attacker from modifying the backup locking configuration information 295. The device locking unit 265 may compare the backup locking configuration information 295 to determine whether the locking configuration information 290 has been modified.

A notification may be sent to the network operator that the locking configuration information 290 has been modified (optional stage 410). The device locking unit 265 may send a network operator a notification via the transceiver 248 that the locking configuration information 290 has been modified. The notification may be a predetermined notification stored in a memory of the modem 200, or may be generated by the device locking unit 265. The communications between the modem 200 and the wireless network operator may not be identified to a user of the mobile device 120 since the user may have attempted to circumvent the lock placed on the modem 200 and/or the mobile device 120 by the wireless network provider (wireless network operator).

The device locking unit 265 may render the modem 200 temporarily unusable in response to determining that the locking configuration information 290 has been modified (e.g., deleted or corrupted) as discussed above with respect to FIG. 2. The device locking unit 265 may permit the modem 200 to establish a network connection with a wireless network for a predetermined period of time to allow the modem to notify the wireless network operator that the locking configuration information 290 has been modified. The device locking unit 265 may be configured to permit the modem 200 to establish a network connection using a SIM card or SIM profile for another network operator. A SIM card for the other network operator may have been inserted into the modem 200 or the mobile device 120 comprising the modem 200, or an eUICC of the modem 200 or the mobile device 120 may have been programmed to utilize a SIM profile for the other network operator by a user attempting to use the mobile device 120 with the other network operator. The device locking unit 265 may permit the device 120 to establish a WLAN, WiFi, and/or other type of wireless network connection to attempt to contact the wireless network operator. Once a network connection has been established, the device locking unit 265 may send the notification to the wireless network provider over the network connection.

The notification sent to the wireless network operator may include various information identifying the modem 200 and/or the mobile device 120 which comprises the modem 200. The notification may include an International Mobile Equipment Identity (IMEI) associated with the mobile device 120 comprising the modem 200. The notification may include location information associated with the mobile device 120. For example, the device locking unit 265 may obtain or determine a location of the mobile device based on signals received from GNSS satellites, WLAN base stations, WiFi access points, location beacons, and/or other sources of positioning information. The device locking unit 265 may obtain a position solution from the SPS receiver 308 of the mobile device 120 or from a network entity associated with the wireless network to which the modem 200 has established a connection. The notification may include other information, such as an identifier of a wireless base station or wireless access point to which the modem 200 has established the network connection. The identifier of the wireless base station may, for example, be a Cell ID associated with the base station on which the mobile device has camped.

The device locking unit 265 may take one or more actions in response to being unable to establish a network connection to transmit the notification to the wireless network operator and/or not receiving a response to the notification from the wireless network operator. The device locking unit 265 may render the modem 200 unusable by making the modem 200 unable to establish a wireless network connection to send or receive data wirelessly. The device locking unit 265 may temporarily render the modem 200 unusable, and periodically reenable the ability of the modem 200 to establish a wireless network connection. The device locking unit 265 may make an attempt to establish a network connection and to send the notification to the wireless network operator. The device locking unit 265 may once again render the modem 200 unusable if the network connection cannot be established, e.g., within a first threshold amount of time or threshold number of attempts, or no response is received from the wireless network operator within a second threshold amount of time (and the first and second threshold amounts of time may be the same or different).

The device locking unit 265 may be configured to render the modem 200 permanently unusable in response to the device locking unit 265 unsuccessfully attempting to notify the wireless network operator (e.g., at least a threshold number of times or threshold amount of time) and/or not receiving a response from the wireless network operator (e.g., at least within a threshold amount of time). The wireless network provider may configure the threshold number of attempts to be made before rendering the modem 200 permanently inoperable. The device locking unit 265 may render the modem 200 permanently inoperable using various techniques. For example, the device locking unit 265 may corrupt or delete the contents of the OTPM 230, the memory 275, and/or other memory of the modem 200 to render data and/or program code stored therein unusable. The contents of the OTPM 230 may be corrupted by blowing all of the fuses or antifuses so that the memory is exhausted.

The device locking unit 265 may be configured to restore the locking configuration information 290 from the backup locking configuration information 295 in implementations where such backup data are available. The device locking unit 265 may attempt to establish a network connection and send a notification to the wireless network operator before restoring the locking configuration information 290 from the backup locking configuration information 295. The device locking unit 265 may restore the locking configuration information 290 responsive to being unable to establish the network connection to send the notification or in response to not receiving a response from the wireless network operator, e.g., within a predetermined amount of time. The device locking unit 265 may be configured to restore the locking configuration information 290 to the modem 200 rather than rendering the modem 200 permanently unusable where the backup locking configuration information 295 is available on the modem 200. However, the device locking unit 265 may still render the modem 200 unusable in response to restoring the information more than a threshold number of times. Repeated deletion or corruption of the locking configuration information 290 may indicate continued attempts to unlock the device by deleting or corrupting the locking configuration information 290.

The device locking unit 265 may receive a response on behalf of the wireless network operator in response to the notification sent by the device locking unit 265. As discussed above, the network operator is an entity that provides network connectivity and/or other network-based services. The response sent on behalf of the network operator may be sent to the mobile device 120 by the wireless network server 180, or by another network entity associated with the network operator. The response may include information that may be used to restore the locking configuration information 290 and/or may include a copy of the locking configuration information 290. The response may instruct the device locking unit 265 to recover the locking configuration information 290 using the backup locking configuration information 295 stored on the modem 200. The response may indicate that the device should be rendered permanently unusable. The response may instruct the device locking unit 265 to limit the functionality of the modem 200 to permit the user to enter an unlock code that may be obtained from the wireless network operator via a user interface of the mobile device 120 to unlock the mobile device 120 for use with another network, e.g., of another network service provider. The modem 200 may prevent the sending or receiving of other data until the unlock code is provided and validated by the wireless network operator. In some instances, the response from the wireless network operator may include an indication that the modem 200 has been unlocked for use with another network of another network service provider. The response from the wireless network operator may be digitally signed or include other means for verifying that the response from the wireless network server 180 has not been spoofed.

Returning again to FIG. 4, the modem 200 may be configured to operate with restored locking configuration information in response to the locking configuration information having been modified (stage 415). For example, the modem 200 may be caused to use the restored locking information in response to the device locking unit 265 detecting the modification and/or in response to a notification of the modification, e.g., generated by the device locking unit. Also or alternatively, the modem 200 may be caused to use the restored locking information based on the response on behalf of the network operator to the notification sent to the network operator indicating that the locking configuration information had been modified. The restored locking configuration information may be obtained as discussed herein. The device locking unit 265 may replace the modified locking configuration information with the backup locking configuration information 295. The device locking unit 265 may replace the locking configuration information 290 that has been modified with the backup locking configuration information 295 by copying the backup locking configuration information 295 from a memory location where the backup locking configuration information 295 is stored to a memory location where the locking configuration information 290 was stored. The backup locking configuration information 295 may be stored in a different memory than the locking configuration information 290. The backup locking configuration information 295 may be encrypted or otherwise protected, and the device locking unit 265 may decrypt or otherwise process, as appropriate, the backup locking configuration information 295 to produce the locking configuration information that replaces the locking configuration information 290 that was modified. As another example, the device locking unit 265 may replace the modified locking configuration information 290 based on locking configuration information received from the wireless network operator. The device locking unit 265 may receive a copy of the locking configuration information 290 from the network operator via a wireless connection (e.g. WLAN, WWAN, or other type of wireless connection). The wireless network connection may be established via any of the wireless communication protocols supported by the modem 200, and the locking configuration information may be received by the modem 200 via an RF front-end, such as the WWAN front-end 240 or the WLAN front-end 245 illustrated in FIG. 2. The device locking unit 265 may change a format of the information received from the network operator via a wireless connection into a format of the locking configuration information 290.

The modem may be operated using the restored locking configuration information (stage 420). The device locking unit 265 may reboot or reset before the modem 200 uses the restored locking configuration information 290. Stages 415 and 420 may not be performed where the device locking unit 265 does not receive a response from the wireless network operator and there is no backup locking configuration information 295 available on the modem 200. Stages 415 and 420 may not be performed where the modem 200 is rendered unusable, e.g., in response to repeated failed attempts to notify the wireless network operator that the locking configuration information 290 has been modified (e.g., deleted or corrupted), and/or in response to the modem 200 receiving a response from the wireless network operator to render the device unusable.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine-readable media, such as random-access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Such media also provide examples of non-transitory media, which may be machine readable, and wherein computers are an example of a machine that may read from such non-transitory media.

Furthermore, the methods, systems, and devices discussed above are examples. Various configurations may omit, substitute, or add various procedures or components as appropriate. For instance, in alternative configurations, the methods may be performed in an order different from that described, and various steps may be added, omitted, or combined. Also, features described with respect to certain configurations may be combined in various other configurations. Different aspects and elements of the configurations may be combined in a similar manner. Also, technology evolves, and thus many of the elements are examples and other elements, including elements developed in the future, may be used.

The generic principles discussed herein may be applied to other implementations.

1. A mobile device comprising:
a memory;
a transceiver for sending and receiving wireless data;
a processor, communicatively coupled to the memory and the transceiver, the processor configured to:
make a determination that locking configuration information for locking the mobile device for use with a wireless network of a wireless network operator has been modified;
temporarily render the mobile device unusable in response to the determination that the locking configuration information has been modified;
periodically reenable an ability of the transceiver to establish a wireless connection with the wireless network operator;
configure the mobile device to use restored locking configuration information in response to the determination that the locking configuration information has been modified; and
perform operations using the restored locking configuration information in response to the mobile device being configured to use the restored locking configuration information.

2. The mobile device of claim 1, wherein the processor is configured to:
attempt to obtain the restored locking configuration information; and
return the mobile device to an unusable status in response to failing to obtain the restored locking configuration information.

3. The mobile device of claim 1, wherein the processor is configured to:
attempt to establish the wireless connection with the wireless network operator; and
return the mobile device to an unusable status in response to failing to establish the wireless connection with the wireless network operator.

4. The mobile device of claim 1, wherein the processor is configured to permanently render the mobile device unusable in response to failing to receive the restored locking configuration information via the wireless connection with the wireless network operator within a threshold number of requests sent to the wireless network operator.

5. The mobile device of claim 1, wherein the processor is configured to obtain the restored locking configuration information from the wireless network operator in response to being powered up a first time subsequent to the processor rendering the mobile device unusable.

6. The mobile device of claim 1, wherein the processor is configured to obtain the restored locking configuration information from the wireless network operator via the wireless connection.

7. The mobile device of claim 1, wherein the processor is further configured to obtain the restored locking configuration information from a protected copy of the locking configuration information stored in the memory.

8. The mobile device of claim 1, wherein the processor is further configured to determine, by analyzing the locking configuration information, that the mobile device should be locked to operate only with the wireless network of the wireless network operator.

9. The mobile device of claim 8, wherein to determine that the mobile device should be locked to operate only with the wireless network of the wireless network operator, the processor is configured to determine whether a fuse indicative of the mobile device being locked has been blown in a one-time programmable memory of the mobile device.

10. The mobile device of claim 1, wherein the processor is further configured to send a notification via the transceiver to the wireless network operator that the locking configuration information has been modified, wherein the notification comprises information identifying the mobile device.

11. A method for detecting and correcting information modification in a mobile device, the method comprising:
making a determination that locking configuration information for locking the mobile device for use with a wireless network of a wireless network operator has been modified;
temporarily rendering the mobile device unusable in response to the determination that the locking configuration information has been modified;
periodically reenabling an ability of a transceiver to establish a wireless connection with the wireless network operator;
configuring the mobile device with restored locking configuration information in response to the determination that the locking configuration information has been modified; and
performing operations using the restored locking configuration information in response to the mobile device being configured to use the restored locking configuration information.

12. The method of claim 11, further comprising:
attempting to obtain the restored locking configuration information; and
returning the mobile device to an unusable status in response to failing to obtain the restored locking configuration information.

13. The method of claim 12, further comprising:
attempting to establish the wireless connection with the wireless network operator; and
returning the mobile device to an unusable status in response to failing to establish the wireless connection with the wireless network operator.

14. The method of claim 12, further comprising permanently rendering the mobile device unusable in response to failing to receive the restored locking configuration information via the wireless connection with the wireless network operator within a threshold number of requests sent to the wireless network operator.

15. The method of claim 11, further comprising attempting to obtain the restored locking configuration information from the wireless network operator in response to being powered up a first time subsequent to rendering the mobile device unusable.

16. The method of claim 11, wherein configuring the mobile device with the restored locking configuration information comprises receiving the restored locking configuration information for the mobile device from the wireless network operator via the wireless connection.

17. The method of claim 11, further comprising obtaining the restored locking configuration information from a protected copy of the locking configuration information stored in a memory of the mobile device.

18. The method of claim 11, further comprising determining that the mobile device should be locked to operate only with the wireless network of the wireless network operator prior to detecting that the locking configuration information has been modified.

19. The method of claim 18, wherein determining that the mobile device should be locked to operate only with the wireless network of the wireless network operator comprises determining that a fuse indicative of the mobile device being locked has been blown in a one-time programmable memory of the mobile device.

20. The method of claim 11, further comprising sending a notification to the wireless network operator that the locking configuration information has been modified, wherein the notification comprises information identifying the mobile device.

21. A mobile device comprising:
means for making a determination that locking configuration information for locking the mobile device for use with a wireless network of a wireless network operator has been modified;
means for temporarily rendering the mobile device unusable in response to the determination that the locking configuration information has been modified;
means for periodically reenabling an ability of the transceiver to establish a wireless connection with the wireless network operator;
means for configuring the mobile device to use restored locking configuration information in response to the determination that the locking configuration information has been modified; and
means for performing operations using the restored locking configuration information in response to the mobile device being configured to use the restored locking configuration information.

22. The mobile device of claim 21, further comprising:
means for attempting to obtain the restored locking configuration information; and
means for returning the mobile device to an unusable state in response to failing to obtain the restored locking configuration information.

23. The mobile device of claim 21, further comprising:
means for establishing the wireless connection with the wireless network operator; and
means for returning the mobile device to an unusable state in response to failing to establish the wireless connection with the wireless network operator.

24. The mobile device of claim 23, wherein the means for returning the mobile device to an unusable state in response to failing to establish the communication connection with the wireless network operator are for returning the mobile device to an unusable state in response to failing to receive the restored locking configuration information via the wireless connection with the wireless network operator within a threshold number of requests sent to the wireless network operator.

25. The mobile device of claim 23, further comprising means for obtaining the restored locking configuration information from the wireless network operator in response to being powered up a first time subsequent to rendering the mobile device unusable.

26. A non-transitory, computer-readable medium, having stored thereon computer-readable instructions for detecting and correcting information modification in a mobile device, comprising instructions configured to cause a processor of the mobile device to:
make a determination that locking configuration information for locking the mobile device use with a wireless network of a wireless network operator has been modified;
temporarily render the mobile device unusable in response to the determination that the locking configuration information has been modified;
periodically reenable an ability of the transceiver to establish a wireless connection with the wireless network operator;
configure the mobile device to use restored locking configuration information in response to the determination that the locking configuration information has been modified; and
perform operations using the restored locking configuration information in response to the mobile device being configured to use the restored locking configuration information.

27. The non-transitory, computer-readable medium of claim 26, further comprising instructions configured to cause the processor to:
attempt to obtain the restored locking configuration information; and
return the mobile device to an unusable status in response to failing to obtain the restored locking configuration information.

28. The non-transitory, computer-readable medium of claim 27, further comprising instructions configured to cause the processor to:
establish the wireless connection with the wireless network operator; and
return the mobile device to an unusable status in response to failing to establish the wireless connection with the wireless network operator.

29. The non-transitory, computer-readable medium of claim 27, further comprising instructions configured to cause the processor to permanently render the mobile device unusable in response to failing to receive the restored locking configuration information via the wireless connection with the wireless network operator within a threshold number of requests sent to the wireless network operator.

30. The non-transitory, computer-readable medium of claim 26, further comprising instructions configured to cause the processor to obtain the restored locking configuration information from the wireless network operator in response to being powered up a first time subsequent to the processor rendering the mobile device unusable.
